(19) United States
(12) Patent Application Publication
(10) Pub. No.: US 2010/0017702 A1
(43) Pub. Date: Jan. 21, 2010

(54) Asynchronous Partial Page Updates Based On Dynamic Dependency Calculation

(75) Inventors: Paul Lloyd Hawes Carroll, Lakeway, TX (US); Samar Choudhary, Morrisville, NC (US); Richard Adam King, Cary, NC (US); Shikha Srivastava, Cary, NC (US)

Correspondence Address: Kenneth P. Waszkiewicz/IBM;Attorney at Law, 29 Murray Avenue, Annapolis, MD, 21401, US

(73) Assignee: INTERNATIONAL BUSINESS MACHINES CORPORATION, Armonk, NY (US)

(21) Appl. No.: 12/174,353

(22) Filed: Jul. 16, 2008

(51) Int. Cl. G06F 17/00

(52) U.S. Cl. 715/234

(57) ABSTRACT

A system and method for asynchronously updating a web page or web pages displayed on a computer. The method receives from the computer an event message that is generated as a response to an action by a user to change an object displayed on the web page. The method creates a dynamic dependency graph having a root node, and child nodes that depend upon the root node, and adds the object that generated the event message, or a reference to the object, to the dependency graph as the root node. In addition, the child nodes may add other child nodes. The method receives context information for other objects displayed on the web page, when a dependency exists between the object and the other objects. The method adds the other objects, or references to the other objects, to the dependency graph as the child nodes. The method traverses the dependency graph and sends update requests to the web page or web pages displayed on the computer, wherein the update requests are sent to the object associated with the root node, and the other objects associated with the child nodes.

### BACKGROUND OF THE INVENTION

1. Field of the Invention

The present invention relates, in general, to computing systems in a distributed data processing environment. In particular, the present invention is a system and method for updating objects displayed on a web page or across multiple web pages of a web portal by dynamically computing a dependency graph.

2. Description of the Related Art

A mashup is a web application that assembles application elements and data from more than one source into a single integrated view. A consumer mashup combines user interface and data elements from multiple sources, hiding this behind a simple graphical user interface. A data mashup mixes data of similar types from different sources. An enterprise mashup integrates user interface and data elements from internal and external sources. A business mashup combines a consumer mashup and data mashup to create a business application user interface that focuses on data aggregation and presentation, and adding collaborative functionality.

A user interacting with an application element in a mashup can affect other application elements in the mashup. For example, if the user selects a resource in one application element, the other application elements that display information about that resource may change. Similarly, when the user changes a display setting in an application element from graphical to tabular, the change may propagate to other application elements in the mashup.

To provide the experience of a locally installed application for the user of a late bound assembled web application, prior art solutions rendered everything on the web page for every request, employed frames and Iframes to isolate the content by embedding another HTML document in a main document, or used Asynchronous JavaScript and XML (Ajax) programming to update individual page portions. These prior art solutions either do not allow for select fragments to be updated on the same or different web page by calculating dynamic relationships, are time and resource intensive, or fall short in user experience.

Due to the increased prevalence of mashup applications, there is a need for new solutions for the unplanned interoperation of application elements. A typical mashup application integrates independently developed application elements without the ability to determine how the application elements affect one another. To avoid the need to render the entire display each time an application element changes, there is a demand for a system and method for asynchronously updating a web page or other web pages displayed on a computer when an action by a user changes an object displayed on the web page. The presently disclosed method and system satisfies this demand.

### SUMMARY OF THE INVENTION

A system and method for asynchronously updating a web page or web pages displayed on a computer. The method receives from the computer an event message that is generated as a response to an action by a user to change an object displayed on the web page. The method creates a dependency graph having a root node, and child nodes that depend upon the root node, and adds the object that generated the event message, or a reference to the object, to the dependency graph as the root node. In addition, the child nodes may add other child nodes. The method calculates the dynamic dependency graph between objects on the web page or web pages and receives context information for the other objects. The method traverses the dependency graph and sends update requests to the web page or web pages displayed on the computer, wherein the update requests are sent to the object associated with the root node, and the other objects associated with the child nodes.

In one embodiment, the web page is a web portal page displayed on a client computer, and the objects displayed on the web portal page are portlets. The action by the user to change one of the portlets may be a user interaction with a component displayed on the portlet. The action generates a processAction method call that is sent from the client computer to a web portal server on a server computer. The web portal server handles the processAction method call, and creates a dependency graph for the portlet that generated the processAction method call. A portlet container for the web portal server receives any context information communicated to other portlets on the portal page or any other page that depend, either directly or indirectly, upon the portlet that changed. The web portal server traverses the dependency graph and sends a renderRequest method call to each portlet in the portal page that is associated with a node in the dependency graph.

### BRIEF DESCRIPTION OF THE DRAWINGS

FIG. 1 is a network diagram that illustrates the hardware components comprising one embodiment of a system that performs the present invention.

FIG. 2 is a block diagram that illustrates one embodiment of the system components shown in FIG. 1.

FIG. 3 is a block diagram that illustrates one embodiment of a web portal page displayed on the client computer 120 shown in FIG. 2.

FIG. 4 is a diagram that illustrates one embodiment of a dependency graph for the web portal page shown in FIG. 3.

FIG. 5 is a flow chart that illustrates one embodiment of the method for asynchronously updating a web page displayed on a computer.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable mediums may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

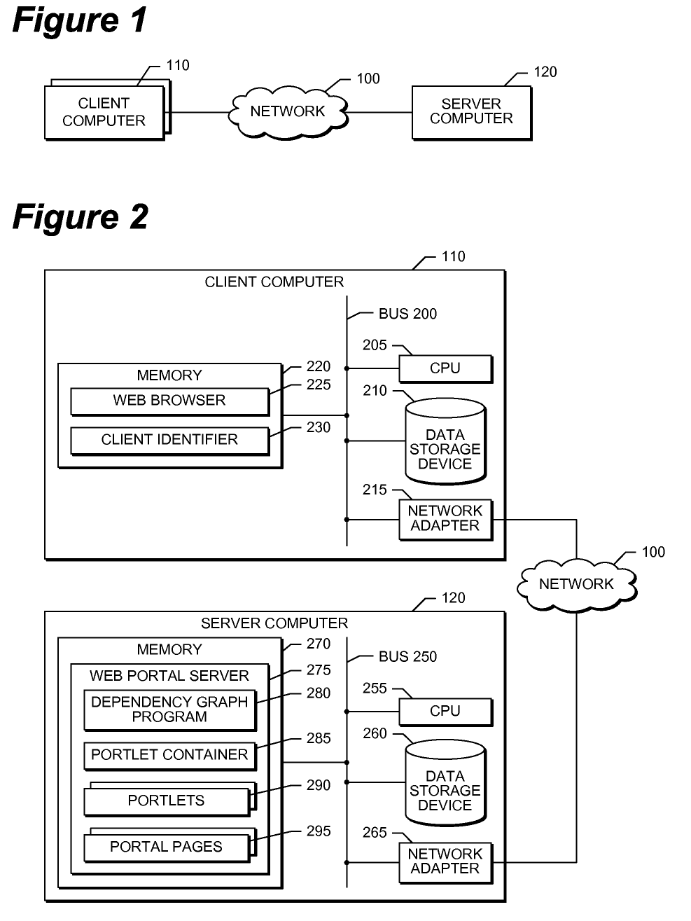

FIG. 1 is a network diagram that illustrates the hardware components comprising one embodiment of a system that performs the present invention. The architecture shown in FIG. 1 utilizes a network 100 to connect a number of client computers 110 to a single server computer 120 that performs the method of the present invention. In another embodiment, the server computer 120 distributes the processing that it performs among a number of server computers. In yet another embodiment, the server computer 120 distributes the processing that it performs among a combination of a server computer and a number of general-purpose computers. In yet another embodiment, the server computer 120 distributes the processing that it performs among the client computers 110 and the server computer 120.

The network 100 shown in FIG. 1, in one embodiment, is a public communication network that connects and enables data transfer between the client computers 110 and the server computer 120. The present invention also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA) or Code Division Multiple Access (CDMA) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

FIG. 2 is a block diagram that illustrates one embodiment of the system components shown in FIG. 1. In particular, FIG. 2 illustrates, in greater detail, the hardware and software components that comprise the server computer 120 and the client computer 110.

As shown in FIG. 2, the client computer 110 is a general-purpose computer. A bus 200 is a communication medium that connects a central processor unit (CPU) 205, data storage device 210, network adapter 215, and memory 220. The network adapter 215 also connects to the network 100 and is the mechanism that facilitates the passage of network traffic between the client computer 110 and the network 100.

The CPU 205 can be a commercially available or custom microprocessor that performs the disclosed methods by executing the sequences of operational instructions that comprise each computer program resident in, or operative on, the memory 220. It is to be understood that the memory 220 may include operating system, administrative, and database programs that support the programs disclosed in this application. The memory 220 is representative of the overall hierarchy of memory devices containing the software and data used to implement the functionality of the client computer 110. The memory 220 can include, but is not limited to, cache, ROM, PROM, EPROM, EEPROM, flash memory, SRAM, and DRAM. In one embodiment, the configuration of the memory 220 of the client computer 110 includes a web browser 225, and a client identifier 230. These computer programs store intermediate results in the memory 220, or data storage device 210. In another embodiment, the memory 220 may swap these programs, or portions thereof, in and out of the memory 220 as needed, and thus may include fewer than all of these programs at any one time.

In one embodiment, the client identifier 230 is stored in a file referred to as a cookie. The server computer 120 may assign and send the client identifier 230 to the client computer 110 once when the client computer 110 first communicates with the server computer 120. From then on, the client computer 110 includes its client identifier 230 with all messages sent to the server computer 120 so the server computer 120 can identify the source of the message.

The server computer 120 shown in FIG. 2 is a general-purpose computer that provides server functionality including file services, web page services, and the like. A bus 250 is a communication medium that connects a central processor unit (CPU) 255, data storage device 260, network adapter 265, and memory 270. The network adapter 265 also connects to the network 100 and is the mechanism that facilitates the passage of network traffic between the server computer 120 and the network 100.

The CPU 255 can be a commercially available or custom microprocessor that performs the disclosed methods by executing the sequences of operational instructions that comprise each computer program resident in, or operative on, the memory 270. It is to be understood that the memory 270 may include operating system, administrative, and database programs that support the programs disclosed in this application. The memory 270 is representative of the overall hierarchy of memory devices containing the software and data used to implement the functionality of the server computer 120. The memory 270 can include, but is not limited to, cache, ROM, PROM, EPROM, EEPROM, flash memory, SRAM, and DRAM. In one embodiment, the configuration of the memory 270 of the server computer 120 includes a web portal server 275 that includes a dependency graph program 280, portlet container 285, portlets 290, and portal pages 295. These computer programs store intermediate results in the memory 270, or data storage device 260. These programs also receive input from the client computers 110, and display the results to the client computers 110. In another embodiment, the memory 270 may swap these programs, or portions thereof, in and out of the memory 270 as needed, and thus may include fewer than all of these programs at any one time.

The web portal server 275, in one embodiment, is a web application deployed in an application server that uses a servlet for handling requests to the web portal server 275. The web portal server 275 receives requests, such as portal events, and hypertext transfer protocol (HTTP) requests, from the client computers 110 to access the portal pages 295, which are identified by uniform resource locator (URL) addresses, and provides the portal pages 295 in response. The web portal server 275 also communicates the requests from the client computers 110 to the portlet container 285. The portlet container 285 controls the access, lifetime, and interaction of the portlets 290 and provides the content returned from a portlet back to the web portal server 275 for merging with the content of other portlets 290. The portlet container 285 then invokes the portlets 290, small Java program that runs within the portlet container 285, to receive and respond to the requests from the portlet container 285. For certain types of events, the web portal server 275 invokes the dependency graph program 280.

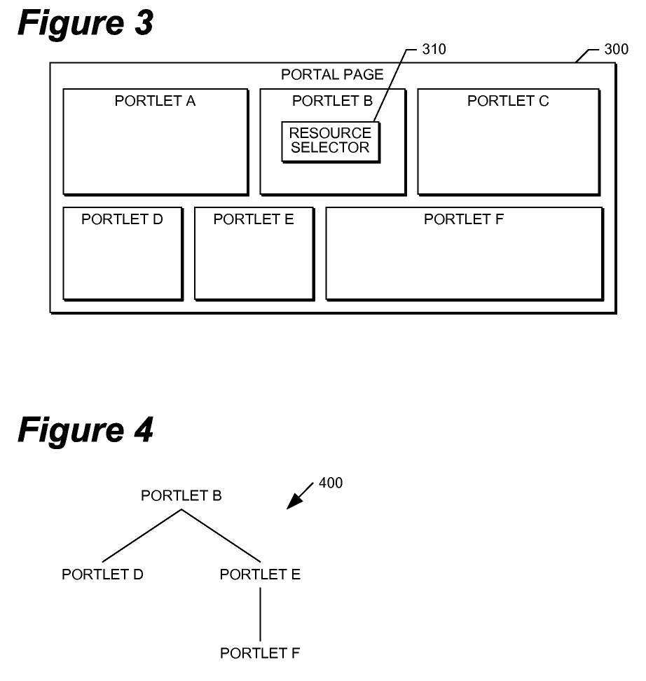

FIG. 3 is a block diagram that illustrates one embodiment of a portal page displayed on the client computer 110 shown in FIG. 2. Portal page 300 shown in FIG. 3 is supplied by the web portal server 275 shown in FIG. 2 and displayed to a user of client computer 110. The portal page 300 shown in FIG. 3 is partitioned into six panels, portlet A, portlet B, portlet C, portlet D, portlet E, and portlet F. In other embodiments, the number and configuration of the panels (i.e., portlets) may vary. Each portlet shown in FIG. 3 displays data and content (not shown) provided by the web portal server 275. Each portlet may further include panel components. In the embodiment shown in FIG. 3, portlet B includes a resource selector 310 component. A user may operate the resource selector 310 component to select one resource from a list of resources that the user may associate with portlet B. When the resource associated with portlet B changes, the portlet sends a request or event, such as a processAction method call, to the web portal server 275. The web portal server 275 invokes the dependency graph program 280 to construct a dynamic dependency graph based on the requesting portlet, portlet B, and the other portlets displayed on the portal page 300 that depend, either directly or indirectly, upon the resource selected by the resource selector 310 component to display data or content associated with the selected resource. The web portal server 275 then uses the computed dependency graph to send requests to the client computer 110 to update the display only for those portlets affected by the change in the resource selector 310 component.

FIG. 4 is a diagram that illustrates one embodiment of a dependency graph for the web portal page shown in FIG. 3. The dependency graph 400 shown in FIG. 4 illustrates that portlet B, after receiving a processAction method call, communicated context information to portlet D and portlet E to send notification of the change in the resource selector 310 component. The dependency graph 400 also illustrates that portlet E also communicated context information to portlet F to send notification of the change in the resource selector 310 component. Based on the dependency graph 400, the web portal server 275 will send requests, such as a renderRequest, to update the display only for portlet B, portlet D, portlet E, and portlet F. Consequently, the web portal server 275 will not send a request to update the display of the other portlets on portal page 300, portlet A, and portlet C, because the change to the selected resource did not affect the display of the other portlets.

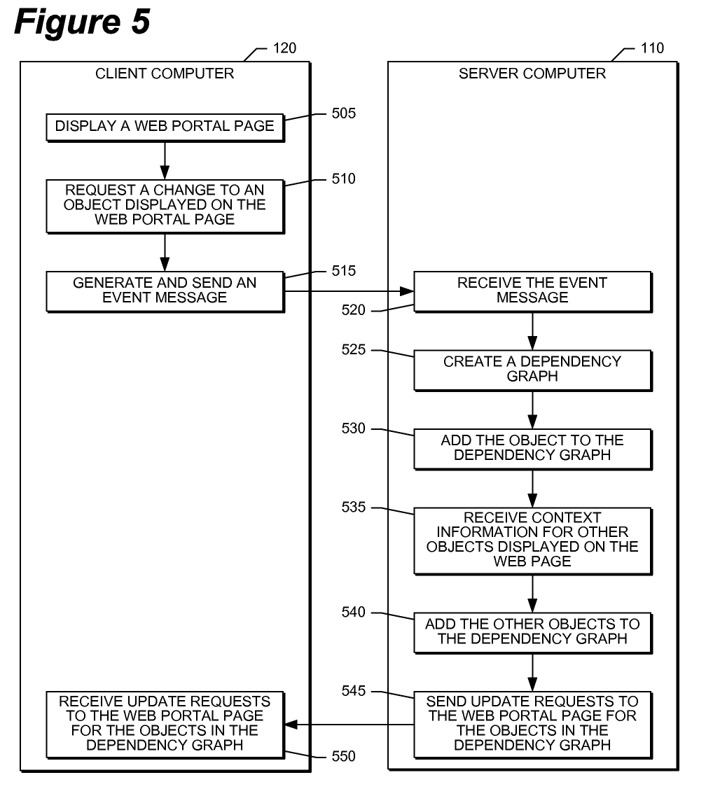

FIG. 5 is a flow chart that illustrates one embodiment of the method for asynchronously updating a web page displayed on a computer. With reference to the system components shown in FIG. 2, the method shown in FIG. 5 begins with the display of one of the portal pages 295 in the web browser 225 of the client computer 110 (step 505). A user operates the client computer 110 to request a change to one of the objects displayed on the portal page 295 (step 510). The objects displayed on the portal page 295 may include application elements, applets, servlets, portlets 290, or the like. The client computer 110 generates an event message in response to the request to change one of the objects displayed on the portal page 295, and sends the event message to the server computer 120 (step 515). The event message may include a processAction method call, or the like.

The server computer 120 receives the event message (step 520) from the client computer 110 and creates a dependency graph (step 525). The dependency graph is a directed acyclic graph that includes a root node and child nodes that represent a dependency relation to the root node. The server computer 120 adds the object on the portal page 295 that the user changed as the root node for the dependency graph (step 530). In another embodiment, the dependency graph stores a reference to the object, rather than the object. The portlet container 285 receives context information from other objects displayed on the portal page 295 that will change as a result of the change to the object that the user changed (step 535). The server computer 120 adds these other objects on the portal page 295 to the dependency graph as child nodes (step 540). In another embodiment, the dependency graph stores a reference to the other objects, rather than the other objects. The server computer 120 traverses the dependency graph and sends update requests to the portal page 295 for each objects on the portal page 295 associated with a node in the dependency graph (step 545). The update request may include a renderRequest method call, or the like. The client computer 110 receives the update requests and renders the object on the portal page 295 associated with each update request (step 550).

The method illustrated in FIG. 5 computes the dependency graph for those objects on the portal page 295 that need to be updated to process the request from the user to change the object. One of ordinary skill in the art will understand that the method illustrated in FIG. 5 allows the server computer 120 to compute the dependency graph dynamically, thereby computing a separate dependency graph for each user interaction with the portal page 295. In addition, computing the dependency graph dynamically with each user interaction allows only the rendering that is necessary to take place, and accommodates unknowable application behaviors, such as adding or removing an object on the portal page 295. The computed dependency graph is a structure for determining which objects in the portal page 295 will be rendered for a given user interaction with the portal page 295. The dependency graph provides automated updates of dependent page fragments without any user intervention and the ability to deliver context to only related user interface elements. The fragments of the portal page 295 may be provided by different web applications. Furthermore, the method of FIG. 5 provides better useability of the portal page 295, reduced latency on response time as the unwanted fragments are left in-place, reduces the bandwidth needed to render the display, the ability to load all the dependent fragments in one asynchronous call, keeps fragments that don't change in cache, and avoids page flicker.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for asynchronously updating at least one web page displayed on a computer, comprising:
receiving an event message from the computer, wherein the event message is a response to an action by a user to change an object displayed on said at least one web page;
creating a dynamic dependency graph having a root node, and at least one child node that depend upon the root node;
adding the object to the dynamic dependency graph as the root node;
receiving context information for other objects displayed on said at least one web page, wherein a dependency exists between the object and the other objects;
adding the other objects to the dynamic dependency graph as said at least one child node; and
sending update requests to said at least one web page displayed on the computer, wherein the update requests are sent to the object associated with the root node, and the other objects associated with said at least one child node.

2. The method of claim 1, wherein the objects displayed on said at least one web page are portlets, applets, or the like.

3. The method of claim 1, wherein the event message is a processAction method call.

4. The method of claim 1, wherein the adding of the object further comprises: storing a reference to the object.

5. The method of claim 1, wherein the dependency is a direct dependency when the action by the user to change the object triggers a change to the other objects, and wherein the dependency is an indirect dependency when the action by the user to change the object triggers a change to a first one of the other objects, which triggers a change to a second one of the other objects.

6. The method of claim 1, wherein the adding of each other object further comprises:
storing a reference to each other object.

7. The method of claim 1, wherein the update request is a render request.

8. The method of claim 1, wherein the sending of the update requests further comprises: traversing the dynamic dependency graph.

9. A system for asynchronously updating at least one web page stored on a computer, comprising:
a memory device resident in the computer; and
a processor disposed in communication with the memory device, the processor configured to:
receive an event message from the computer, wherein the event message is a response to an action by a user to change an object displayed on said at least one web page;
create a dynamic dependency graph having a root node, and at least one child node that depend upon the root node;
add the object to the dynamic dependency graph as the root node;
receive context information for other objects displayed on said at least one web page, wherein a dependency exists between the object and the other objects;
add the other objects to the dynamic dependency graph as said at least one child node; and
send update requests to said at least one web page displayed on the computer, wherein the update requests are sent to the object associated with the root node, and the other objects associated with said at least one child node.

10. The system of claim 9, wherein the objects displayed on said at least one web page are portlets, applets, or the like.

11. The system of claim 9, wherein the event message is a processAction method call.

12. The system of claim 9, wherein to add the object, the processor is further configured to: store a reference to the object.

13. The system of claim 9, wherein the dependency is a direct dependency when the action by the user to change the object triggers a change to the other objects, and wherein the dependency is an indirect dependency when the action by the user to change the object triggers a change to a first one of the other objects, which triggers a change to a second one of the other objects.

14. The system of claim 9, wherein to add each other object, the processor is further configured to:
store a reference to each other object.

15. The system of claim 9, wherein the update request is a render request.

16. The system of claim 9, wherein to send the update requests, the processor is further configured to:
traverse the dynamic dependency graph.

17. A computer program product for asynchronously updating at least one web page stored on a computer, comprising:
a computer readable medium storing:
program code for receiving an event message from the computer, wherein the event message is a response to an action by a user to change an object displayed on said at least one web page;
program code for creating a dynamic dependency graph having a root node, and at least one child node that depend upon the root node;
program code for adding the object to the dynamic dependency graph as the root node;
program code for receiving context information for other objects displayed on said at least one web page, wherein a dependency exists between the object and the other objects;
program code for adding the other objects to the dynamic dependency graph as said at least one child node; and
program code for sending update requests to said at least one web page displayed on the computer, wherein the update requests are sent to the object associated with the root node, and the other objects associated with said at least one child node.

18. The computer program product of claim 17, wherein the program code for adding the first object further comprises:
program code for storing a reference to the object.

19. The computer program product of claim 17, wherein the program code for adding each other object further comprises:
program code for storing a reference to each other object.

20. The computer program product of claim 17, wherein the program code for sending the update requests further comprises:
program code for traversing the dynamic dependency graph.
